(19) United States
(12) Patent Application Publication
(10) Pub. No.: US 2011/0046252 A1
(43) Pub. Date: Feb. 24, 2011

(54) REACTION RESIN BASED ON AN UNSATURATED POLYESTER, VINYL COMPOUNDS AND HYDROCARBON NANOTUBES THAT CAN BE CURED RADICALLY

(76) Inventors: Stefan Bahnmueller, Singapore (SG); Helmut Meyer, Odenthal (DE); Helmut Ritter, Wuppertal (DE); Michael Klink, Krefeld (DE); Serguei Kostromine, Swisttal-Buschhoven (DE)

Correspondence Address: CONNOLLY BOVE LODGE & HUTZ, LLP, P O BOX 2207, WILMINGTON, DE, 19899, US

(21) Appl. No.: 12/989,212

(22) PCT Filed: Apr. 9, 2009
(86) PCT No.: PCT/EP2009/002663

§ 371 Date: Oct. 22, 2010

(30) Foreign Application Priority Data
Apr. 22, 2008 (DE) 10 2008 020 135.9

(51) Int. Cl. C08L 67/00; C09J 167/00; C08J 9/00; C09D 167/00

(52) U.S. Cl. 521/149; 525/242; 525/302

(57) ABSTRACT

The present invention relates to reaction resins based on an unsaturated polyester, one or more vinyl compounds and hydrocarbon nanotubes that can be cured radically, wherein hydrocarbon nanotubes are covalently bound to the unsaturated polyester.

The invention relates to a curable moulding composition reinforced with carbon nanotubes (also referred to hereinbelow as CNTs for short) and comprising at least one unsaturated polyester resin (referred to as UP resin for short) and at least one radically polymerisable vinyl monomer, the carbon nanotubes being covalently bonded to the unsaturated polyester resin.

UP resins are known per se. They possess a large number of polymerisable double bonds, which serve mainly as crosslinking component in the polymerisation of the vinyl monomer miscible therewith and accordingly effect curing of the resin (Ullmann's Encyclopedia of Industrial Chemistry, 1992 v.A21).

UP resins can be used widely as a moulding composition, in particular for various applications in the building, construction and electrical industry. Examples of processing methods that are used are compression and injection moulding processes. Subsequent curing is carried out thermally, usually with the action of organic peroxides as initiators, which are added to the UP moulding compositions during their preparation.

In order to keep up with constantly increasing demands in terms of the mechanical stability of the polymer parts under load, the moulding compositions are conventionally provided with reinforcing agents (glass fibres, mineral fillers, such as talcum and calcium carbonate, carbon fibres and various carbon blacks). It is frequently found that the improvement of one material property (e.g. strength) is associated with a marked impairment of one or more other properties (e.g. fracture toughness).

In the more recent past, more and more nanoparticulate fillers have become known, in which this contrary effect as regards strength and fracture toughness is not so strongly pronounced. Carbon nanotubes (CNTs), which possess an outstanding combination of mechanical and physical properties, occupy a special position in this group. Known carbon nanotubes having a perfect crystalline structure have a diameter in the nanometre range and reach a length of up to 1 mm or more. They have a very high modulus of elasticity of up to about 1 TPa and a strength of from 50 to 100 GPa. In addition, they are excellent electrical and thermal conductors. It is to be expected in principle that such nanotubes, when incorporated into thermoplastic and thermoreactive polymeric compositions, can not only have a positive effect on their mechanical profile but can also render the material electrically conductive. This additional option is particularly important in the case of the UP resins, because such composites based on UP resins are often used in the electrical and electronics industry.

Works have recently become known in which both single-walled carbon nanotubes (SWCNTs) and multi-walled carbon nanotubes (MWCNTs) are used as additives in UP resins.

Offenlegungsschrift WO 2005/108485A2 describes the possible preparation of stable dispersions of unmodified CNTs in various polymer matrices (PVC, PVCC, PVDF, PMMA, PC, PA, PE, PS, PVA, PVAc, inter alia). The CNTs are stabilised in the polymer matrices by addition of a copolymer which contains acid, amino and anhydride groups and is soluble in the above-mentioned polymers. The ratio of CNTs to polymer [m(CNT)/m(copolymer)] is from 0.001 wt. % to 1.0 wt. %.

Patent specification EP 1 580219 B1 describes a process for the preparation of composite materials reinforced with CNTs. The process also includes hydrophilic CNTs, that is to say those which carry hydrophilic groups. In order to obtain a resin raw material reinforced with CNTs, the CNTs and the finished polymer are dispersed in different solvents, the two solutions are mixed together, and the solvents are removed. The hydrophilic groups are introduced into the CNTs by irradiation with UV light, by plasma treatment and/or by wet treatment with a strong oxidising agent. The resin material includes epoxy resins, phenolic resins, melamine resins, furan resins and unsaturated polyester resins. The raw material reinforced with CNTs is processed further by the injection moulding process and the compression moulding process.

Ago et al. (Adv. Mater. 2002, 14, 19, 1380-1383) investigated the preparation of composite materials based on CNTs and unsaturated polyesters in a magnetic field.

Studies by Tanoglu and Schubert (European Polymer Journal, 2007, 43, 2, 374-379) show that unsaturated polyesters, reinforced with non-functionalised CNTs and with CNTs carrying amino groups, have a higher tensile strain than the pure polymer. They were able to establish that the tensile elongation of the resulting materials increases as the amount of CNTs in the composite material increases.

The object of the present invention was to find possibilities for using CNTs in resins comprising unsaturated polyesters that bring about a further substantial improvement in the mechanical properties of the resulting moulded bodies while using as low a total concentration of CNTs as possible.

All the studies carried out hitherto have one thing in common: The SWCNTs or MWCNTs used as additives are present as a physical mixture alongside the polymer matrix.

Surprisingly, it has been found that, when CNTs are introduced into a UP resin moulding composition, in particular in an amount of from 0.001 to 1.0 wt. %, in such a manner that they are covalently bonded to the unsaturated polyester resin, a substantial increase in the tensile strain strength of the composite to a level of at least 15 N/mm², in some cases even to a level of at least 25 N/mm², is achieved.

Comparison tests have shown that these values exceed the tensile strength of the sample without CNTs by at least 300%. The reinforcement that is obtained is markedly greater than that achieved when non-covalently bonded CNTs are used.

The invention provides a reaction resin based on an unsaturated polyester, one or more radically curable vinyl compounds and carbon nanotubes, characterised in that the carbon nanotubes are covalently bonded to the unsaturated polyester.

The invention also provides the unsaturated polyester which has entered into at least one covalent bond with at least one CNT particle and which can be used in this form as a fundamental component for the preparation of the polyester resin.

Preference is given to a reaction resin which is characterised in that the unsaturated polyester is composed of units of
a) α,β-unsaturated acid components,
b) one or more polyhydric alcohols, and
c) modified carbon nanotubes which carry one or more carboxylic acid or alcohol groups.

Unsaturated polyester within the scope of the invention is understood as meaning condensation products which possess the ester group (—COO—) and carbon-carbon double bonds (—CH═CH—) in their polymer backbone. Such products are generally prepared by melt or azeotropic condensation from polyvalent, in particular divalent, carboxylic acids and their esterifiable derivatives, in particular their anhydrides or alkyl esters, which are linked in an ester-like manner to polyhydric, in particular dihydric, alcohols, and optionally contain additional radicals of monovalent carboxylic acids or monohydric alcohols, at least some of the materials used having ethylenically unsaturated copolymerisable groups.

The materials used also include carbon nanotubes which are so modified that they carry at least one chemical grouping which is able to enter into at least one ester bond with the other materials used in the condensation, which ester bond bonds the carbon nanotubes to the polymer backbone.

Preference is given to a reaction resin which is characterised in that the resin contains from 20 to 90 wt. %, preferably from 30 to 80 wt. %, particularly preferably from 50 to 75 wt. %, unsaturated polyester having covalently bonded carbon nanotubes.

There come into consideration as carriers of the carbon-carbon double bonds in particular α,β-unsaturated dicarboxylic acids or unsaturated diols, preference being given to α,β-unsaturated dicarboxylic acids.

Particularly preferred α,β-unsaturated acid components are citraconic, fumaric, itaconic, mesaconic and maleic acid and their anhydrides or alkyl esters, preferably methyl esters, with fumaric acid, maleic acid and the anhydride thereof being most particularly preferred.

As further acid components there can additionally be used for the condensation reaction that is relevant to the invention aliphatic, cycloaliphatic and/or aromatic mono-, di- and/or poly-carboxylic acids, such as sebacic acid, dodecanedioic acid, adipic acid, azelaic acid, 1,4-cyclohexanedicarboxylic acid, hexahydrophthalic acid, methylhexahydrophthalic acid, tetrahydrophthalic acid, phthalic, isophthalic, terephthalic acids, trimellitic and promellitic acids. Such acid components can be present wholly or partially in the form of anhydrides or alkyl, preferably methyl, esters.

There are used as a further component the modified carbon nanotubes, which carry at least one carboxyl group per carbon nanotube. Such carbon nanotubes are understood as being in particular both single-wall carbon nanotubes (SWCNTs) and multi-wall carbon nanotubes (MWCNTs), preferably multi-wall carbon nanotubes (MWCNTs), which are treated with a strong oxidising agent, such as, for example, fuming nitric acid, so that they are able to form carboxylic acid groups at the ends of the particles and at defective sites on the surface of the nanotubes. Such modified carbon nanotubes per se, which carry carboxylic acid groups, and processes for their preparation are known in principle (H. Hu, R. C. Haddon; Chem. Phys. Let. 2001, 304, 25).

The oxidising agent used for the functionalisation of the carbon nanotubes is preferably an oxidising agent from the group: nitric acid, hydrogen peroxide, ozone, potassium permanganate and sulfuric acid or a possible mixture of these agents. Nitric acid or a mixture of nitric acid and sulfuric acid is preferably used, and nitric acid is particularly preferably used.

Preference is given also to a reaction resin which is characterised in that the carbon nanotubes are functionalised with oxygen-containing groups from the group —OH and —COOH, which are at least partially involved in the covalent bond with the polyester.

Particular preference is given to a reaction resin in which the proportion of functional groups —OH and/or —COOH of the carbon nanotubes is at least 5 mol %, preferably at least 10 mol %.

Carbon nanotubes within the scope of the invention are all single-walled or multi-walled carbon nanotubes of the cylinder type, scroll type or having an onion-type structure. Preferably, multi-walled carbon nanotubes of the cylinder type, scroll type or mixtures thereof are to be used.

The carbon nanotubes are used in the finished compound in particular in an amount of from 0.01 to 10 wt. %, preferably from 0.1 to 5 wt. %, based on the mixture of polymer and carbon nanotubes. In masterbatches, the concentration of carbon nanotubes is optionally higher.

Particularly preferably, carbon nanotubes having a length to outside diameter ratio of greater than 5, preferably greater than 100, are used.

The carbon nanotubes are particularly preferably used in the form of agglomerates, the agglomerates in particular having a mean diameter in the range from 0.05 to 5 mm, preferably from 0.1 to 2 mm, particularly preferably from 0.2 to 1 mm.

The carbon nanotubes that are to be used particularly preferably have substantially a mean diameter of from 3 to 100 nm, preferably from 5 to 80 nm, particularly preferably from 6 to 60 nm.

In contrast to the known CNTs of the scroll type mentioned at the beginning having only one continuous or broken graphene layer, CNT structures have recently been found that consist of several graphene layers, which are combined to a stack and are present in rolled-up form (multiscroll type). These carbon nanotubes and carbon nanotube agglomerates thereof are, for example, provided by the as yet unpublished German patent application having the official file reference 102007044031.8. The contents thereof in respect of the CNTs and their preparation are hereby incorporated into the disclosure of this application. The behaviour of this CNT structure relative to carbon nanotubes of the simple scroll type is comparable to that of the structure of multi-walled cylindrical monocarbon nanotubes (cylindrical MWNTs) relative to the structure of single-walled cylindrical carbon nanotubes (cylindrical SWNTs).

Unlike in the onion-type structures, the individual graphene or graphite layers in these carbon nanotubes obviously run, when viewed in cross-section, continuously from the centre of the CNTs to the outside edge without interruption. This can enable the improved and more rapid intercalation of other materials in the tube structure, for example, because more open edges are available as entry zones for the intercalates as compared with CNTs having a simple scroll structure (Carbon 34, 1996, 1301-3) or CNTs having an onion-type structure (Science 263, 1994, 1744-7).

The methods known today for the preparation of carbon nanotubes include arc, laser ablation and catalytic processes. In many of these processes, carbon black, amorphous carbon and fibres having a large diameter are formed as by-products. In the case of the catalytic processes, a distinction can be made between deposition on supported catalyst particles and deposition on metal centres formed in situ having diameters in the nanometre range (so-called flow processes). In the case of preparation via the catalytic deposition of carbon from hydrocarbons that are gaseous under reaction conditions (CCVD; catalytic carbon vapour deposition hereinbelow), acetylene, methane, ethane, ethylene, butane, butene, butadiene, benzene and further, carbon-containing starting materials are mentioned as possible carbon donors. CNTs obtainable from catalytic processes are therefore preferably used.

The catalysts generally contain metals, metal oxides or decomposable or reducible metal components. For example, Fe, Mo, Ni, V, Mn, Sn, Co, Cu and further subgroup metals are mentioned in the prior art as metals for the catalyst. Although most of the individual metals tend to assist the formation of carbon nanotubes, high yields and low contents of amorphous carbons are advantageously achieved according to the prior art with metal catalysts that are based on a combination of the above-mentioned metals. CNTs obtainable using mixed catalysts are consequently preferably to be used.

Particularly advantageous catalyst systems for the preparation of CNTs are based on combinations of metals or metal compounds which contain two or more elements from the group Fe, Co, Mn, Mo and Ni.

Experience has shown that the formation of carbon nanotubes and the properties of the tubes that are formed are dependent in a complex manner on the metal component or a combination of a plurality of metal components used as catalyst, on the catalyst support material which is optionally used and the interaction between the catalyst and the support, on the starting material gas and partial pressure, on an addition of hydrogen or further gases, on the reaction temperature and on the residence time or the reactor used.

A process which is particularly preferably to be used for preparing carbon nanotubes is known from WO 2006/050903 A2.

The various processes mentioned hitherto using various catalyst systems yield carbon nanotubes of various structures, which can be removed from the process predominantly in the form of carbon nanotube powder.

Carbon nanotubes that are more preferably suitable for the invention are obtained by processes which are described in principle in the following literature references:

The preparation of carbon nanotubes having diameters less than 100 nm is described for the first time in EP 205 556 B1. There are used for the preparation light (i.e. short- and medium-chained aliphatic or mono- or di-nuclear aromatic) hydrocarbons and a catalyst based on iron, on which carbon carrier compounds are decomposed at a temperature above 800-900° C.

WO86/03455A1 describes the preparation of carbon filaments which have a cylindrical structure with a constant diameter of from 3.5 to 70 nm, an aspect ratio (ratio of length to diameter) greater than 100 and a core region. These fibrils consist of many continuous layers of ordered carbon atoms, which are arranged concentrically around the cylindrical axis of the fibrils. These cylinder-like nanotubes were prepared by a CVD process from carbon-containing compounds by means of a metal-containing particle at a temperature of from 850° C. to 1200° C.

WO2007/093337A2 discloses a process for the preparation of a catalyst which is suitable for the preparation of conventional carbon nanotubes having a cylindrical structure. When this catalyst is used in a fixed bed, relatively high yields of cylindrical carbon nanotubes having a diameter in the range from 5 to 30 nm are obtained.

A completely different method of preparing cylindrical carbon nanotubes has been described by Oberlin, Endo and Koyam (Carbon 14, 1976, 133). In this method, aromatic hydrocarbons, for example benzene, are reacted on a metal catalyst. The resulting carbon nanotubes exhibit a well defined, graphitic hollow core which has approximately the diameter of the catalyst particle, on which further less graphitically ordered carbon is found. The entire carbon nanotube can be graphitised by treatment at a high temperature (2500° C.-3000° C.).

Most of the above-mentioned processes (arc, spray pyrolysis and CVD) are used today to prepare carbon nanotubes. The preparation of single-walled cylindrical carbon nanotubes is very expensive in terms of apparatus, however, and proceeds according to the known processes with a very low rate of formation and often also with many secondary reactions, which lead to a high proportion of undesirable impurities, that is to say the yield of such processes is comparatively low. Therefore, the preparation of such carbon nanotubes is even today still extremely technically complex, and they are therefore used in small amounts especially for highly specialised applications. Their use for the invention is conceivable, however, but less preferred than the use of multi-walled CNTs of the cylinder or scroll type.

Multi-walled carbon nanotubes, in the form of seamless cylindrical nanotubes nested inside one another or also in the form of the described scroll or onion structures, are today prepared commercially in relatively large amounts predominantly using catalytic processes. These processes usually exhibit a higher yield than the above-mentioned arc and other processes and are typically carried out today on the kg scale (several hundred kilos/day worldwide). The multi-walled carbon nanotubes so prepared are generally somewhat less expensive than the single-walled nanotubes and are therefore used in other materials, for example as a performance-enhancing additive.

Preferred alcohol components are polyhydric alcohols from the group: linear and/or branched aliphatic and/or cycloaliphatic and/or aromatic diols and/or polyols, such as ethylene glycol, 1,2- and/or 1,3-propanediol, 1,2- and/or 1,4-butanediol, 1,3-butyl-ethylpropanediol, 1,3-methylpropanediol, 1,5-pentanediol, 1,6-hexanediol, diethylene, triethylene, tetraethylene glycol, cyclohexanedimethanol, glycerol, neopentyl glycol, trimethylolethane, trimethylolpropane, pentaerythritol, bisphenol A, B, C, F, neobornylene glycol, 1,4-benzyldimethanol and 1,4-benzyldiethanol, particularly preferably butanediol.

The alcohol component is used in particular in a molar ratio of from 0.8 to 1.5 to 1 relative to the sum of the acid components including the carbon nanotubes. The ratio of the alcohol component to the sum of the acid components is preferably from 0.9 to 1.1 to 1.

The unsaturated polyesters are prepared by processes known in principle from the prior art by melt condensation or condensation under azeotropic conditions at a temperature of from 80 to 220° C. from their above-mentioned starting components by continuous or batchwise processes.

In order to prepare the curable moulding composition, at least one polymerisable vinyl monomer is usually mixed with the unsaturated polyester. For example, styrene, α-methylstyrene, vinyltoluene, methyl methacrylate, vinyl acetate, diallyl phthalate and diallyl isophthalate are added. Styrene is particularly preferred.

The amount by weight of the added vinyl monomer is preferably from 5 to 70% of the total moulding composition. An amount by weight of the added vinyl monomer of from 30 to 60 wt. % is particularly preferred.

A further constituent of the curable moulding composition (reaction resin), which is in particular from 0.1 to 4 wt. % and preferably from 0.2 to 2 wt. %, is a polymerisation initiator. Conventional peroxides that decompose to radicals above 50° C., such as diacyl peroxide, peroxy dicarbonates, peroxy esters, perketals, hydroxy peroxides, ketoperoxides and dialkyl peroxides, can be used as initiators. Typical azo initiators are also suitable.

It is possible to add to the novel reaction resin further components from the group: fillers, pigments, dispersing agents, stabilisers, lubricants and flameproofing agents; liquid additives, in particular water or oils and/or gaseous fillers, in particular air, nitrogen or carbon dioxide.

There can be added as further fillers, colourings and pigments chalk, quartz flour, talcum, kaolin in amounts of from 0 to 300 wt. %. Liquid additives such as water or oils, and/or gaseous fillers, such as air, nitrogen, carbon dioxide, can optionally also be used.

There are preferably added as a shrinkage-reducing or plasticising agent thermoplastic polymers, such as polystyrene, polymethyl methacrylate, polyvinyl acetate, saturated polyesters and thermoplastic polyurethanes, in amounts of from 5 to 50 wt. % (based on the total UP resin).

Oxides and hydroxides of magnesium, zinc or calcium can optionally be added to the moulding composition as a thickening agent. Isocyanates, optionally in combination with amine, can also be used as thickening agents.

Further substances which can be added to the moulding composition are inhibitors, lubricants, accelerators, mould-release agents and flameproofing agents.

In order further to reinforce the moulded bodies, inorganic and/or organic fibres of glass, cellulose, polyethylene, polyamide or carbon fibres in the form of short or long fibres, sheets, woven fabrics or mats can be added to the moulding composition (reaction resin) or incorporated during processing.

The prefabricated moulding composition (reaction resin) is introduced into a mould by filling, pressing or injection and cured at temperatures of from 60 to 200° C.

Likewise, the prefabricated moulding compositions of reaction resin can be applied as coatings, filling compositions, adhesive compositions or as foams and cured.

The invention further provides a process for the preparation of the curable moulding compositions according to the invention comprising unsaturated polyester resin (UP resin) which contains the covalently bonded modified carbon nanotubes.

The novel process for the preparation of the novel reaction resin is characterised in that carbon nanotubes are functionalised by one or more carboxylic acid or alcohol groups by means of oxidation, and the functionalised carbon nanotubes are dispersed in one or more polyhydric alcohols, in particular in a diol, mixed with an unsaturated acid component, in particular maleic acid, fumaric acid or maleic anhydride, and condensed to an unsaturated polyester, wherein the functionalised carbon nanotubes are covalently bonded, and there are added to the polyester one or more vinyl monomers selected from the group: styrene, α-methylstyrene, methyl methacrylate, vinyltoluene, vinyl acetate, diallyl phthalate and diallyl isophthalate, as well as a radical initiator.

In particular, the novel process consists specifically of the following steps described hereinbelow:

Chemical modification of the carbon nanotubes (step 1), which serves to bring the carboxylic acid groups to the surface of the particles. Modification of the carbon nanotubes takes place at elevated temperature in an oxidising acid such as, for example, sulfuric acid or fuming nitric acid. The successful reaction can be detected by means of FT-IR spectroscopy. At a wavelength of 1684 cm⁻¹, a broad band occurs, which is attributable to the carbonyl valence vibration in aromatic carboxylic acids. This chemical modification improves the dispersing behaviour of the CNTs and leads to marked stabilisation of the dispersions.

Preparation of the Unsaturated Polyester by the Condensation Reaction of a Reaction mixture (step 2), consisting of the CNTs modified in step 1, dispersed in a diol, and an unsaturated dicarboxylic acid or its anhydride, which serves to bond the carbon nanotubes covalently to the unsaturated polyester. Such bonding leads to better distribution of the CNTs in the moulding composition and to the secure binding of the CNTs into the polymer network of the cured moulded body. These are the best conditions for obtaining a substantial improvement in the mechanical properties of the moulded body.

The CNTs modified in step 1, in an amount of in particular from 0.001 to 1 wt. %, based on the total weight of the reaction mixture, are very finely suspended in a diol, for example by means of an ultrasonic disintegrator (e.g. from Branson). The exposure to ultrasound takes place in particular in several steps, the breaks serving to cool the dispersion. During the exposure to ultrasound, continuous cooling of the dispersion is additionally to be ensured. A deficient amount, in particular a 5% deficient amount, of anhydride of an unsaturated divalent carboxylic acid is added to the resulting stable suspension, which is flushed with nitrogen in particular at 80° C. After up to 16 hours' preliminary condensation, for example at 100° C., the suspension is then stirred using a water separator in particular for several hours at elevated temperature, for example for 5 hours at 190° C.

The nanotube-polyester reaction product so formed is cooled in particular to 140° C., and a vinyl monomer is added in a weight ratio of in particular from 1:2 to 2:1 (step 3). In order to ensure that the components are mixed thoroughly, the reaction mixture is stirred, in particular for one minute at 140° C., and then cooled to room temperature.

A peroxide initiator is then added to the moulding composition in order to form the reaction resin, and the moulding composition is optionally poured into moulds. Crosslinking of the resin can take place at elevated temperature, for example at 80° C.

In the examples below, comparison samples containing unmodified CNTs or no CNTs at all were prepared according to fundamentally the same measures.

A most particularly preferred form of the invention are unsaturated polyesters having covalently bonded carbon nanotubes and the curable moulding compositions resulting therefrom, which are prepared from the following components by the process described above, wherein
Baytubes C150P from Bayer MaterialScience AG are used as the carbon nanotubes,
maleic anhydride is used as the acid component,
1,4-butanediol is used as the polyhydric alcohol,
styrene is used as the vinyl monomer, and
dibenzoyl peroxide (DBPO) is used as the initiator.

The cured moulded bodies and films obtained thereby were tested as in the examples below:

The invention is explained in greater detail hereinbelow by means of the examples, which do not limit the invention.

### EXAMPLES

### Example 1

### Standard Preparation Procedure

The standard procedure for the preparation of unsaturated polyester resins reinforced with covalently bonded modified MWCNTs and crosslinked with styrene is as follows:

Carbon nanotubes (type Baytubes C 150 P, manufacturer Bayer MaterialScience AG) were oxidised by boiling for 18 hours in fuming nitric acid. The modified carbon nanotubes were separated from the acid by decantation and washed several times with distilled water. Carbon nanotubes modified with carboxylic acid groups were suspended in specific amounts of up to 1 wt. % in butanediol. The suspension was exposed to ultrasound, with cooling, 5 times for 2 minutes by means of a Branson Sonifier W-450 D (depth of immersion of the tip: 1-1.5 cm). The suspension so formed was transferred as completely as possible to a two-necked flask with a septum, a magnetic stirrer bar, a water separator, a reflux condenser and a bubble counter. Based on the mass of the suspension, a 5% molar deficiency of the anhydride component, here maleic anhydride, was added thereto. The suspension was heated to 80° C., with stirring. The suspension was stirred for 3 hours at that temperature. During this time, nitrogen was passed through the suspension for one hour. The mixture was then heated to 100° C. and stirred for 18 hours. It was then heated to 190° C. and stirred for a further 6 hours. During this time, 1-1.2 ml of water separated out in the water separator. The suspension could then be cooled. It is recommended to store it in a freezer.

For further processing, the polyester was heated to 140° C. At that temperature, distilled styrene (in a molar ratio of 1:1 relative to the anhydride component) was added, with vigorous stirring. The mixture was stirred for one minute at that temperature and then cooled to room temperature as quickly as possible. The dispersion is then sufficiently liquid to be processed further. 4 wt. % (based on the total mass of the suspension including the vinyl component) of dibenzoyl peroxide were added, stirring was carried out for a short time, and the mixture was poured into Teflon moulds in order to produce the test specimens. The moulds were placed in an exsiccator, which was flushed with nitrogen for 3 minutes, while closed, and was then placed in a drying cabinet for 16 hours at 80° C. The finished test specimens were lifted carefully using a spatula and removed from the Teflon moulds.

TABLE 1

| | Percent | | Weight mod. | | Weight diol | Weight acid | Weight | Weight |
|---|---|---|---|---|---|---|---|---|
| Sample | MWCNTs | | MWCNTs | | component | anhydride | styrene | DBPO |
| 1 | 0 | wt. % | 0 | mg | 11.83 g | 12.25 g | 13.02 g | 1.48 g |
| 2 | 0.01 | wt. % | 2.4 | mg | 11.5 g | 11.9 g | 12.64 g | 1.44 g |
| 3 | 0.1 | wt. % | 24 | mg | 10.46 g | 10.86 g | 11.53 g | 1.32 g |
| 4 | 1 | wt. % | 240 | mg | 8.0 g | 8.28 g | 8.8 g | 1.0 g |

### Example 2

### Comparison Test

Analogously to Example 1, a sample was prepared which contained the unmodified carbon nanotubes Baytubes C 150 P incorporated therein. The composition can be seen in Table 2.

TABLE 2

| | Percent | Weight mod. | Weight diol | Weight acid | Weight | Weight |
|---|---|---|---|---|---|---|
| Sample | MWCNTs | MWCNTs | component | anhydride | styrene | DBPO |
| 5 | 0.1 wt. % | 24 mg | 10.46 g | 10.86 g | 11.53 g | 1.32 g |

### Example 3

The tensile strain strength was tested according to DIN 53504 using a tensile strain machine from Zwick (force transducer 500 N; displacement sensor: traverse; temperature: room temperature; determination of the film dimensions using a slide gauge). The results are shown in Table 3.

TABLE 3

| | Percent modified | Percent unmodified | Tensile strength of the |
|---|---|---|---|
| Sample | MWCNTs | MWCNTs | sample |
| 1 | 0% | | 5.71 N/mm² |
| 2 | 0.01% | | 29.4 N/mm² |
| 3 | 0.1% | | 24.3 N/mm² |
| 4 | 1% | | 17.5 N/mm² |
| 5 | | 0.1% | 17.5 N/mm² |

In comparison with the unsaturated polyester resins containing unmodified CNTs (Example 5) as resin additive, the unsaturated polyester resins containing modified CNTs exhibit a significantly higher tensile strength in the standard test.

### Example 4

The fracture behaviour of the samples was studied in a 3-point bending test on an Instron 5566 device. The test speed was 5 mm/min. The support spacing was 20 mm. The support/peen diameter was 10 mm and 5 mm. The results are summarised in Table 4.

TABLE 4

| Sample (Example) | | 1 | 2 | 3 | 4 | 5 |
|---|---|---|---|---|---|---|
| Flexural modulus | [MPa] | 525 | 1314 | 1328 | 1102 | 642 |
| Flexural strength | [MPa] | 36.5 | 76.0 | 72.2 | 57.5 | 42.4 |
| Flexural strain at | [%] | 12.0 | 8.8 | 7.7 | 7.9 | 11.2 |
| flexural strength | | | | | | |

The bending test shows a comparatively markedly higher flexural strength of unsaturated polyester resins containing modified CNTs as additive compared with unsaturated polyester resins containing unmodified CNTs as additive.

1-14. (canceled)

15. A reaction resin comprising
a) an unsaturated polyester,
b) a radically curable vinyl compounds,
c) a polymerization initiator, and
d) a carbon nanotube covalently bonded to the unsaturated polyester.

16. The reaction resin according to claim 15, wherein the unsaturated polyester comprises
a) an α,β-unsaturated acid component,
b) a polyhydric alcohol, and
c) a modified carbon nanotube comprising one or more carboxylic acid or alcohol groups.

17. The reaction resin according to claim 15, wherein the radically curable vinyl compound is at least one compound selected from the group consisting of: styrene, α-methylstyrene, vinyltoluene, methyl methacrylate, vinyl acetate, diallyl phthalate, diallyl isophthalate, and mixtures thereof.

18. The reaction resin according to claim 17, wherein the radically curable vinyl compound is present in an amount of 5 to 70 wt. %.

19. The reaction resin according to claim 15, wherein the unsaturated polyester comprises an α,β-unsaturated acid component selected from the group consisting of citraconic, fumaric, itaconic, mesaconic, and maleic acids, anhydrides and alkyl esters thereof.

20. The reaction resin according to claim 15, wherein the α,β-unsaturated acid component is selected from the group consisting of fumaric acid, maleic acid, maleic anhydride, and mixtures thereof.

21. The reaction resin according to claim 15, wherein the carbon nanotubes are present in an amount of not more than 3 wt. %.

22. The reaction resin according to claim 16, wherein the polyhydric alcohol is selected from the group consisting of linear and/or branched aliphatic and/or cycloaliphatic and/or aromatic diols and/or polyols, and mixtures thereof.

23. The reaction resin according to claim 16, wherein the polyhydric alcohol is selected from the group consisting of ethylene glycol, 1,2- and/or 1,3-propanediol, 1,2- and/or 1,4-butanediol, 1,3-butylethylpropanediol, 1,3-methylpropanediol, 1,5-pentanediol, 1,6-hexanediol, diethylene, triethylene, tetraethylene glycol, cyclohexanedimethanol, glycerol, neopentyl glycol, trimethylolethane, trimethylolpropane, pentaerythritol, bisphenol A, bisphenol B, bisphenol C, bisphenol F, neobornylene glycol, 1,4-benzyldimethanol, 1,4-benzyldiethanol, and mixtures thereof.

24. The reaction resin according to claim 16, wherein the polyhydric alcohol is butanediol.

25. The reaction resin according to claim 16, wherein the carbon nanotube is functionalized with oxygen-containing groups from the group —OH and —COOH, which enter at least partially into the covalent bond with the polyester.

26. The reaction resin according to claim 25, wherein the proportion of functional groups —OH and/or —COOH of the carbon nanotube is at least 5 mol %.

27. The reaction resin according to claim 25, wherein the proportion of functional groups —OH and/or —COOH of the carbon nanotube is at least 10 mol %.

28. The reaction resin according to claim 15, wherein the polymerization initiator is present in an amount of 0.1 to 4 wt. %.

29. The reaction resin according to claim 15, wherein the unsaturated polyester comprising covalently bonded carbon nanotubes is present in an amount of 20 to 90 wt. %.

30. A process for the preparation of a reaction resin, comprising
a) providing a carbon nanotube that is functionalized by one or more carboxylic acid or alcohol groups;
b) dispersing the carbon nanotube in a polyhydric alcohol to form a dispersion;
c) mixing the dispersion with an unsaturated acid component to form a mixture;
d) condensing the mixture to an unsaturated polyester, wherein the carbon nanotube is covalently bonded to the polyester;
e) adding one or more vinyl monomers to the polyester, wherein the vinyl monomers are selected from the group consisting of styrene, methylstyrene, methyl methacrylate, vinyl acetate, diallyl phthalate, diallyl isophthalate, and mixtures thereof; and
f) adding a radical initiator to the polyester.

31. The process according to claim 30, wherein the polyhydric alcohol comprises a diol.

32. The process according to claim 30, wherein the unsaturated acid component comprises maleic acid, fumaric acid or maleic anhydride.

33. The process according to claim 30, wherein the dispersion of the carbon nanotubes is assisted by ultrasonic irradiation and the condensation takes place by removal of water at elevated temperature.

34. Moulded bodies, for coatings, as foams and as filling and adhesive compositions comprising the reaction resin according to claim 15.
